(19) United States
(12) Patent Application Publication
(10) Pub. No.: US 2023/0418554 A1
(43) Pub. Date: Dec. 28, 2023

(54) CONTENT OUTPUT CONTROL DEVICE, CONTENT OUTPUT CONTROL METHOD, AND NON-TRANSITORY COMPUTER READABLE STORAGE MEDIUM

(71) Applicant: DENSO CORPORATION, Kariya-city (JP)

(72) Inventors: Daiki KAWASHIMA, Kariya-city (JP); Takuya KONDO, Kariya-city (JP); Kentaro TESHIMA, Kariya-city (JP)

(21) Appl. No.: 18/461,662

(22) Filed: Sep. 6, 2023

Related U.S. Application Data
(63) Continuation of application No. PCT/JP2022/008281, filed on Feb. 28, 2022.

(30) Foreign Application Priority Data
Mar. 23, 2021 (JP) 2021-048699

(51) Int. Cl. G06F 3/16; H04R 3/12; B60Q 9/00

(52) U.S. Cl. CPC G06F 3/165; H04R 3/12; B60Q 9/00; H04R 2499/13

(57) ABSTRACT

An audio content output control device includes a memory, an arbitration unit, and an audio output control unit. The memory stores a rule definition including: an arbitration policy for defining basic arbitration when one of audio contents is assigned to a zone; and a constraint expression. The arbitration unit performs arbitration of the audio contents according to the rule definition to satisfy rule-based arbitration upon receiving output requests of the audio contents. The audio output control unit controls output of the one of the audio contents assigned to the zone when the arbitration of the audio contents is performed by the arbitration unit. The memory stores the rule definition in consideration of requirements specific to the audio contents, respectively. The arbitration unit performs the arbitration of the audio contents in accordance with the rule definition in consideration of the requirements specific to the audio contents.

### CROSS REFERENCE TO RELATED APPLICATIONS

The present application is a continuation application of International Patent Application No. PCT/JP2022/008281 filed on Feb. 28, 2022, which designated the U.S. and claims the benefit of priority from Japanese Patent Application No. 2021-048699 filed on Mar. 23, 2021. The entire disclosures of all of the above applications are incorporated herein by reference.

### TECHNICAL FIELD

The present disclosure relates to a content output control device, a content output control method, and a non-transitory computer readable storage medium.

### BACKGROUND

There has been known a method of arbitrating an output when output requests of a plurality of audio contents are received at the same time.

### SUMMARY

According to an aspect of the present disclosure, an audio content output control device includes a memory, an arbitration unit, and an audio output control unit. The memory stores a rule definition including: an arbitration policy for defining basic arbitration when one of audio contents is assigned to a zone; and a constraint expression. The arbitration unit is configured to perform arbitration of the audio contents according to the rule definition to satisfy rule-based arbitration upon receiving output requests of the audio contents output from applications, respectively. The audio output control unit is configured to control output of the one of the audio contents that is assigned to the zone when the arbitration of the audio contents is performed by the arbitration unit. The memory stores the rule definition in consideration of requirements specific to the audio contents, respectively. The arbitration unit is configured to perform the arbitration of the audio contents in accordance with the rule definition in consideration of the requirements specific to the audio contents.

### BRIEF DESCRIPTION OF DRAWINGS

Objects, features and advantages of the present disclosure will become apparent from the following detailed description made with reference to the accompanying drawings. In the drawings:

FIG. 1 is a functional block diagram showing a configuration of an output control device according to an embodiment;

FIG. 2 is a diagram illustrating properties of a zone;

FIG. 3 is a diagram illustrating definitions of zones;

FIG. 4 is a diagram illustrating the relationship between audio contents, states, and zones;

FIG. 5 is a diagram illustrating properties of audio contents;

FIG. 6 is a diagram illustrating requirements;

FIG. 7 is a diagram illustrating a rule-based arbitration;

FIG. 8 is a diagram illustrating restrictions usable in a display arbitration and an audio arbitration;

FIG. 9 is a flow chart showing the behavior of the overall arbitration logic;

FIG. 10 is a flowchart showing an arbitration process;

FIG. 11 is a diagram illustrating a concept of an output APP request;

FIG. 12 is a diagram illustrating a sequence of a process;

FIG. 13 is a diagram illustrating a sequence of a process; and

FIG. 14 is a diagram illustrating a sequence of the process.

### DETAILED DESCRIPTION

There is a method of comparing values of a plurality of audio contents, preferentially outputting an audio content having a higher value, determining whether or not a display content corresponding to the audio content is output, and variably setting the value of the audio content according to a determination result. In this method, flexible adjustment of the output schedule of the audio content is performed according to the output of the display content, and flexible arbitration is performed according to the information value of the audio content.

In the above method, flexible arbitration is performed by variably setting the value of the audio content according to the output result of the display content corresponding to the audio content. However, since the arbitration between the audio contents is determined by the magnitude of the value of the audio contents, for example, when the output requests of an audio content A having a low value and an audio content B having a high value are simultaneously received, arbitration in which a relationship between the audio contents is “audio content A<audio content B” cannot be performed.

In addition, a method of performing rule-based arbitration is provided as a method of solving enlargement and complication of matrix design due to an increase of contents. For example, there is a method of assigning a content to an area so as to satisfy a constraint expression (propositional logic) when an output request of a display content is received. In this method, the value of the display content is determined according to an arbitration policy of the area, the display content is assigned to the area according to the priority of the area, and the constraint expression is evaluated. When a right side of the constraint expression is determined before a left side is determined, the display content is re-assigned to the area of the right side.

According to the above method, flexible arbitration is performed by the constraint expression that defines an exceptional relationship between audio contents. However, the requirements specific to the audio contents is not taken into consideration. For example, when an output request of an interruption audio content is received while a music content is being output, it is not possible to control a requirement to lower the volume of the music. Since the content of the audio content changes over time, it is necessary to determine whether to output the audio content from the beginning or from the middle. When such requirements specific to the audio contents are managed for respective audio contents, the same logic needs to be prepared for the respective audio contents, and management and implementation become complicated.

According to an aspect of the present disclosure, a content output control device includes a memory, an arbitration unit, and an audio output control unit. The memory stores a rule definition including: an arbitration policy for defining basic arbitration when one of audio contents is assigned to a zone; and a constraint expression. The arbitration unit is configured to perform arbitration of the audio contents according to the rule definition to satisfy rule-based arbitration upon receiving output requests of the audio contents from applications, respectively. The audio output control unit is configured to control output of the one of the audio contents that is assigned to the zone when the arbitration of the audio contents is performed by the arbitration unit. The memory stores the rule definition in consideration of requirements specific to the audio contents, respectively. The arbitration unit is configured to perform the arbitration of the audio contents in accordance with the rule definition in consideration of the requirements specific to the audio contents.

The rule definition in consideration of the requirements specific to the audio contents is stored, and the arbitration of the audio contents is performed according to the rule definition in consideration of the requirements specific to the audio contents. Accordingly, it is possible to easily manage the audio contents, and it is possible to easily change the specification and the design and to improve the quality.

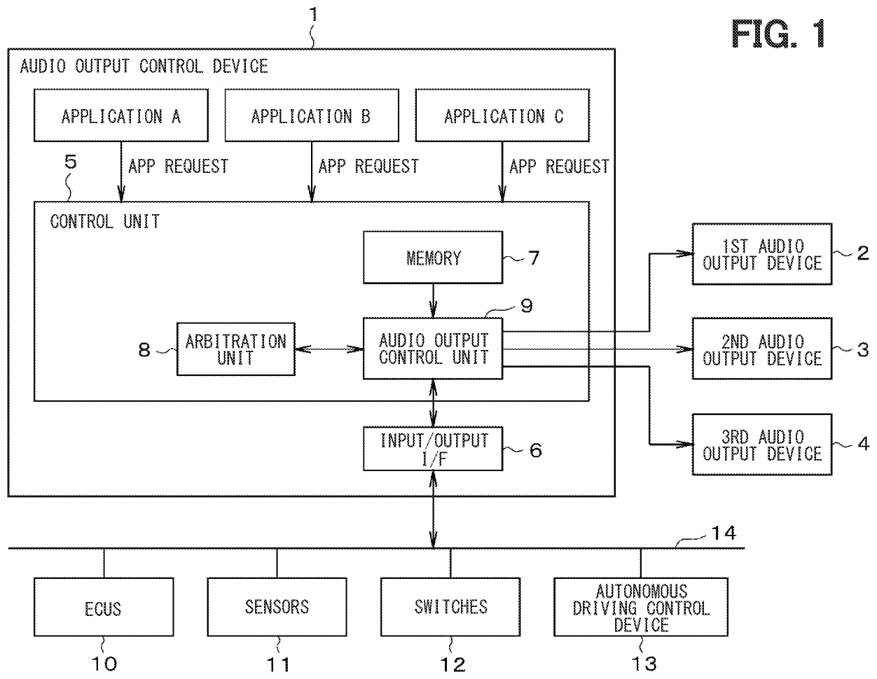

Hereinafter, one embodiment of the present disclosure will be described with reference to the drawings. As illustrated in FIG. 1, an audio output control device 1 is mounted on a vehicle and controls output of audio contents into a vehicle compartment. The audio output control device 1 corresponds to a content output control device. The audio contents include, for example, a navigation audio content, a music content, an interruption audio content, or the like. The audio output control device 1 provides a navigation audio, music, a warning sound, or the like to an occupant including a driver by controlling output of these audio contents.

A plurality of audio output devices 2 to 4 are disposed at predetermined locations in the vehicle compartment. The first audio output device 2 is, for example, a driver seat speaker that is disposed near a driver seat and outputs the audio contents to the driver. The second audio output device 3 is, for example, a front passenger seat speaker that is disposed near a front passenger seat and outputs the audio contents to an occupant in the front passenger seat. The third audio output device 4 is, for example, a rear seat speaker that is disposed near a rear seat and outputs the audio contents to an occupant in the rear seat.

The audio output control device 1 includes a control unit 5 and an input/output I/F 6. The control unit 5 has a microcomputer including a central processing unit (CPU), a read only memory (ROM), a random access memory (RAM), an input/output (I/O), and the like, and executes an output control program stored in a non-transitory computer readable storage medium.

The audio output control device 1 stores a plurality of applications A to C in advance. When an output request of an audio content is generated, each of the applications A to C interrupts and outputs an application (APP) request ON that indicates an audio output device, a zone, and the audio content as output targets to the control unit 5.

The control unit 5 includes a memory 7, an arbitration unit 8, and an audio output control unit 9. The control unit 5 controls the operation of the audio output control device 1 by executing the output control program. The memory 7 stores rule definitions. The rule definitions include an arbitration policy that define basic arbitration when contents are assigned to zones, and a constraint expression that describes properties that should be satisfied exceptionally. The arbitration policy is a value for determining a policy of arbitration for a zone, and includes four policies of a latter-win arbitration, a former-win arbitration, a priority latter-win arbitration, and a priority former-win arbitration. The constraint expression may not be limited to one, and no constraint expression may be provided or a plurality of constraint expressions may be provided according to the intention of the specification developer.

Upon receiving an output request from an application, the arbitration unit 8 arbitrates audio contents according to the rule definitions so as to satisfy a rule-based arbitration (corresponding to an arbitration procedure). The audio output control unit 9 is connected to various ECUs 10, various sensors 11, various switches 12, an autonomous driving control device 13 and the like via an input/output I/F 6 through an in-vehicle network 14 such as a controller area network (CAN). The audio output control unit 9 controls output of an audio content allocated to a predetermined zone by the arbitration unit 8 (corresponding to an audio output control procedure). An arbitration logic can be created as a library, and the rule-based arbitration can be arbitrarily set by registering or changing the rule definitions in the library.

When assigning the audio contents to the zones, different applications may output APP request ON at the same time, which requires arbitration. Note that “at the same time” does not mean temporally at the same time, but means a state in which the audio content of another application has already been output when the APP request ON is output from one application.

When different applications output APP request ON at the same time, it is necessary to arbitrate the audio content to be output to the zone. In a configuration in which all behaviors indicating which audio content is output to which zone are defined, it is difficult to define all of the behaviors when the number of audio contents increases. In view of such circumstances, the present embodiment employs a rule-based arbitration that abstractly represents which audio content is to be output to which zone. Hereinafter, the rule definitions of the audio arbitration will be described.

The rule definitions in the audio arbitration include items of the zone, the audio content, the constraint expression, and the APP request.

### (1) Zone

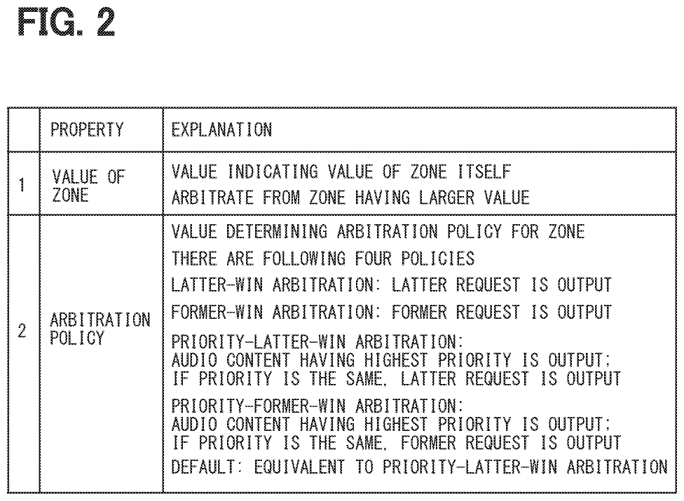

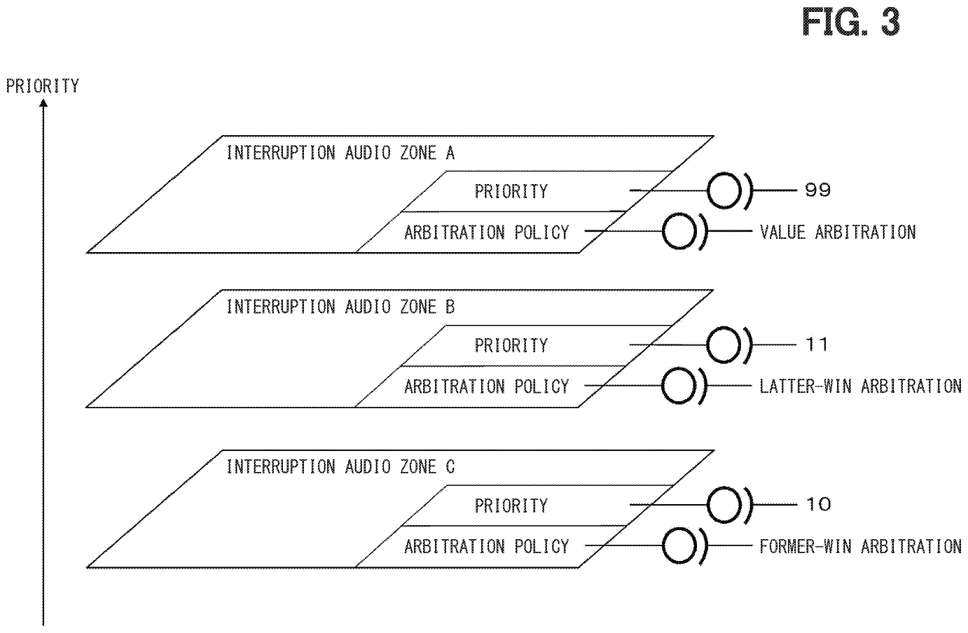

The zone is a rule that defines an output destination of the audio content, and at most one content is assigned to one zone according to an arbitration result. The zone complies with the following rule definitions. The zone acquires an assigned audio content. The zone has an arbitration policy. The zone refers to audio content belonging to the zone. Each zone has properties illustrated in FIG. 2. As illustrated in FIG. 3, the priority and the arbitration policy are set for each zone. In the example illustrated in FIG. 3, an interrupting audio zone A, an interrupting audio zone B, and an interrupting audio zone C have higher priorities in this order.

### (2) Audio Content

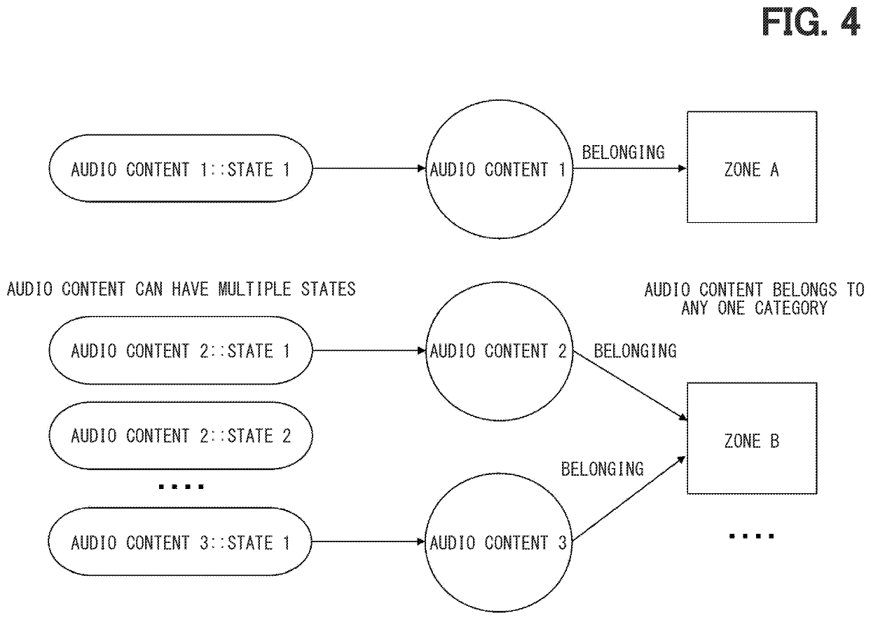

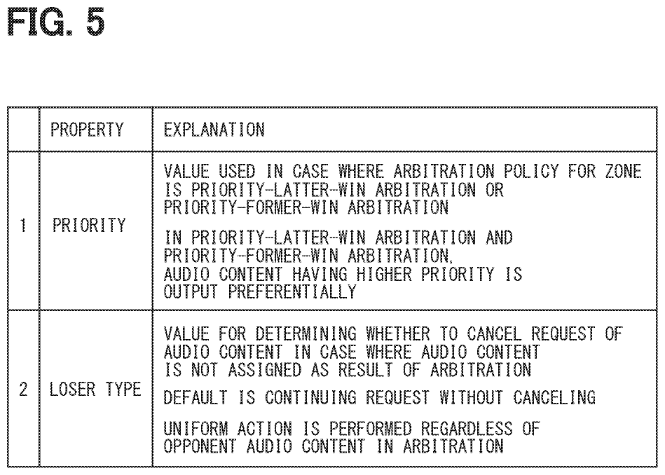

The audio content complies with the following rule definition. The audio content is assigned to the zone. The audio content refers to one or more zones that can output the audio content. The audio content always has one or more states. The audio content can have a plurality of states in one content. When the audio content has a plurality of states, each state is exclusive, and the audio content can be output only in one state at a time. The relationship between the audio contents, the states, and the zones is as illustrated in FIG. 4. The audio content has properties illustrated in FIG. 5.

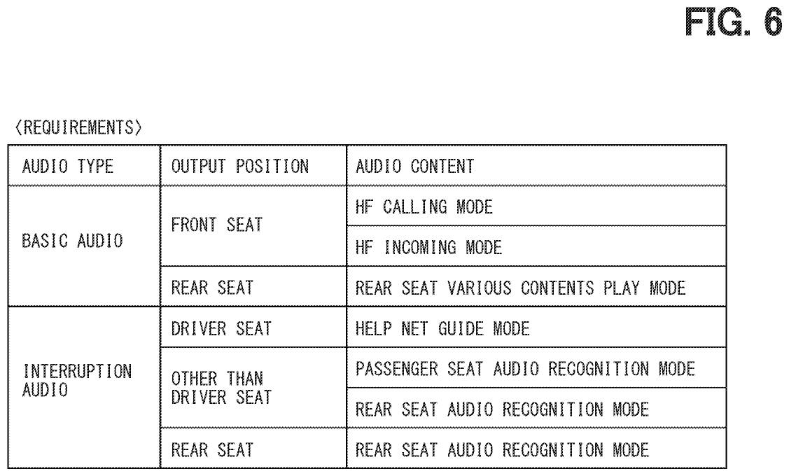

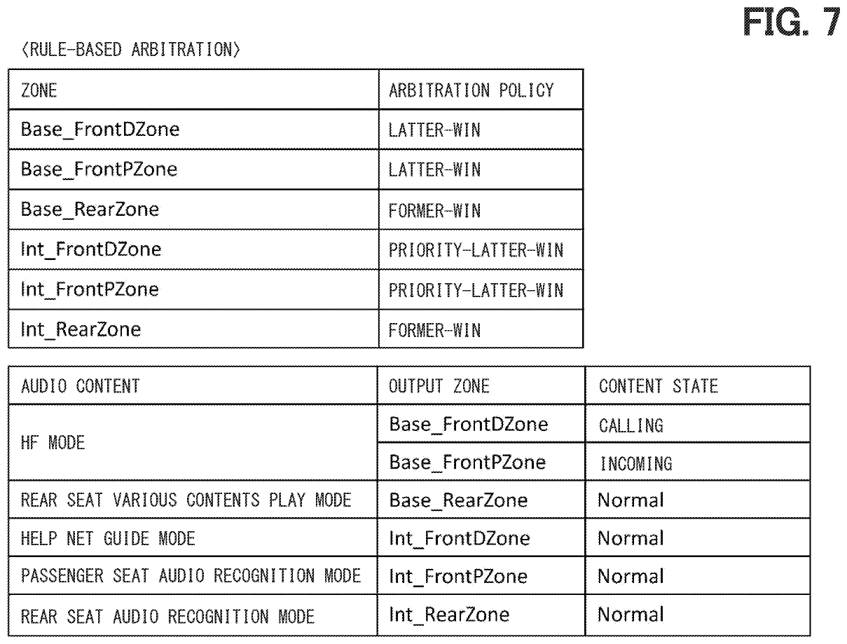

The behavior at the time of losing arbitration is defined in the audio content. The behavior at the time of losing the arbitration is to continue or withdraw the output request when the audio content loses the arbitration, or to withdraw the output request when a state changes from an output state to a non-output state. Note that a uniform operation is performed regardless of an opponent content at the time of losing the arbitration. For example, if the navigation audio content cannot win the arbitration at a timing at which the APP request ON is output, there is a high possibility that the vehicle passes through an intersection even if the navigation audio content is output at a timing at which the output condition is satisfied thereafter. Therefore, the output request is set to be withdrawn as the behavior at the time of losing the arbitration. For requirements shown in FIG. 6, the zones and the audio content are defined according to the rule-based arbitration shown in FIG. 7.

### (3) Constraint Expression

The constraint expression is a rule describing a property to be satisfied during or after arbitration. By suppressing the arbitration result by the constraint expression, it is possible to realize detailed arbitration that cannot be expressed by the arbitration policy or the priority. For example, an interruption audio suppression mode is an audio content to be output to a driver seat interruption zone, and when the interruption audio suppression mode is output, there is a requirement that the content is not output to the interruption zone other than the driver seat. Since the arbitration policy is a rule that can be defined only in units of zones, a constraint expression is used to realize arbitration between a plurality of zones.

The constraint expression is described by a notation based on predicate logic. For example, constraint interruption audio suppression mode and interruption zone other than driver (D) seat

```
    {
  description: “[Audio] Do not output to the interruption zone other than
the D seat during output of the interruption audio suppression mode”
  runtime: true
  interruption audio suppression mode. isSounding ( ) − >! interruption
zone other than seat D. isOutputted ( )
}
```

means “if the interruption audio suppression mode is being output (isSounding), the content is not output to interruption zone other than the D seat”. The arbitration logic operates to satisfy this constraint expression and generates an arbitration result.

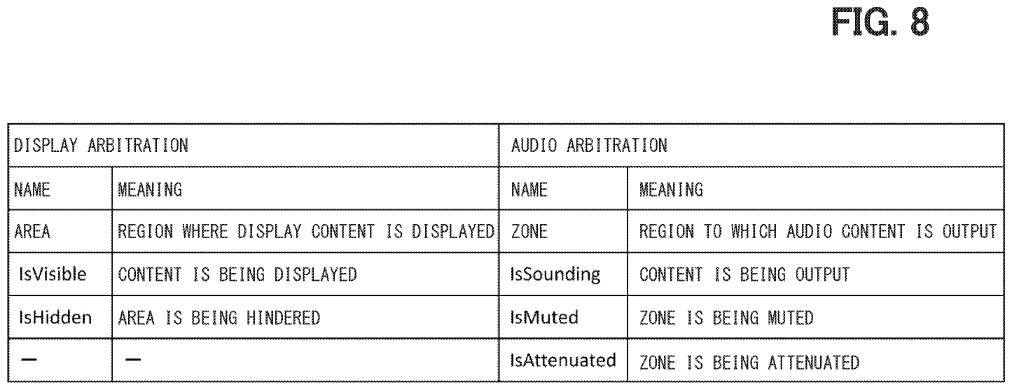

FIG. 8 illustrates a representative example of restrictions usable in a display arbitration and an audio arbitration. The “area” of the display arbitration and the “zone” of the audio arbitration have the same meaning.

Next, the arbitration logic will be described.

### (a) Overall Arbitration Logic Behavior

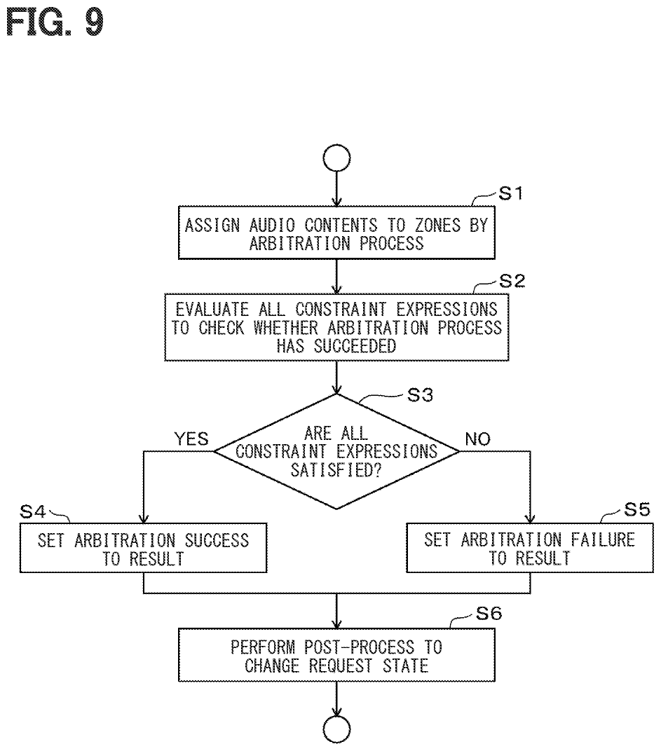

As illustrated in FIG. 9, the audio output control device 1 performs arbitration process, assigns the audio contents to the zones (S1), evaluates all constraint expressions, and checks whether the arbitration process has succeeded (S2). When the audio output control device 1 determines that all the constraint expressions have been satisfied and determines that the arbitration process has succeeded (“YES” at S3), it sets arbitration success to the result and confirms the arbitration (at S4). When the audio output control device 1 determines that any one of the constraint expressions is not satisfied and determines that the arbitration process has failed (“NO” at S3), it sets arbitration failure to the result (at S5). The audio output control device 1 performs post-process to change the state of the request (S6).

(b) Operation of Arbitration Process

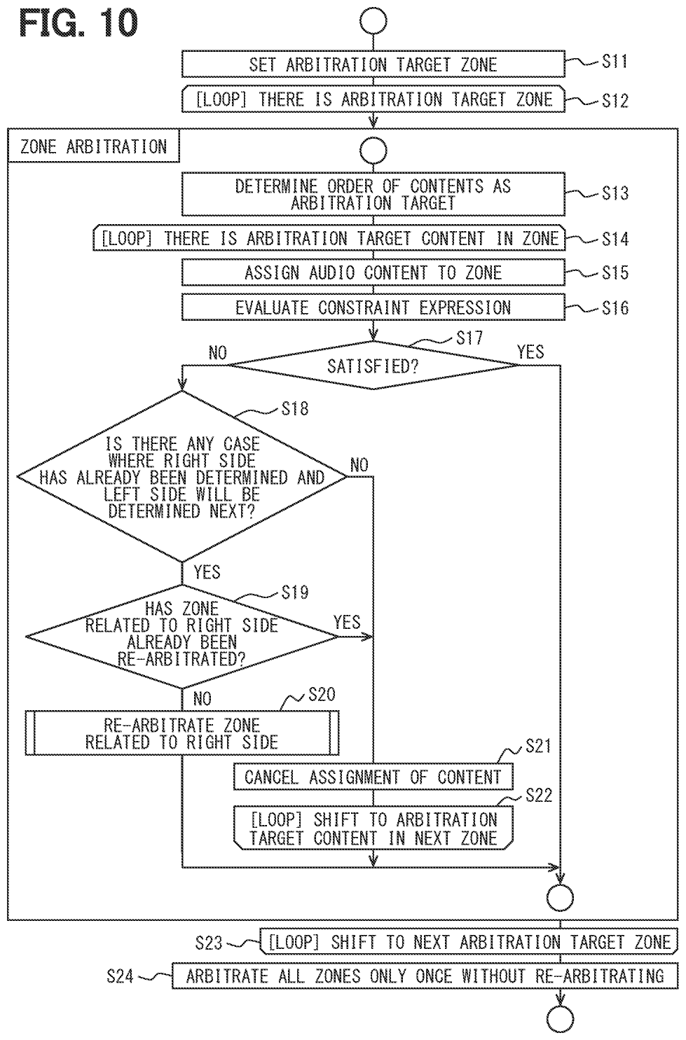

As illustrated in FIG. 10, the audio output control device 1 sets the zones to be arbitrated in descending order of priority (S11), and when there is an arbitration target zone (S12), the audio output control device 1 proceeds to arbitration of the zones. In the zone arbitration, the audio output control device 1 determines the order of the audio contents to be arbitrated in the zones based on the arbitration policy (S13). If there is no arbitration target zone, the loop ends. When the audio content to be arbitrated is present in the zone (S14), the audio output control device 1 assigns the audio content to the zone (S15). If there is no arbitration target zone, the loop ends.

The audio output control device 1 evaluates the constraint expression (S16) and determines whether or not the constraint expression is satisfied (S17). When it is determined that the constraint expression is satisfied (S17: YES), the audio output control device 1 exits from the zone arbitration. When the audio output control device 1 determines that the constraint expression is not satisfied (“NO” at S17), it determines whether or not there is any case where the right side of the implication has already been determined and the left side will be determined next (at S18). When the audio output control device 1 determines that there is a case (“YES” at S18), it determines whether or not the zone related to the right side with the implication has already been re-arbitrated (at S19).

If the audio output control device 1 determines that there is no case (“NO” at S18), or if there is a case but determined that the area related to the right side of the implication has already been re-arbitrated (“YES” at S19), the audio output control device 1 cancels the assignment of the content (at S21), shifts to the arbitration target content in the next zone (at S22), and exits the zone arbitration.

On the other hand, when the audio output control device 1 determines that the zone related to the right side with the implication has not been re-arbitrated yet (“NO” at S19), the audio output control device 1 adds the zone related to the right side with the implication in the order following the arbitration target zone (at S20). When the audio output control device 1 determines that all the loops for shifting to the next arbitration target zone have ended and there is no arbitration target zone (at S23), the audio output control device 1 arbitrates all the zones only once without re-arbitrating all the zones (at S24).

### (4) APP Request

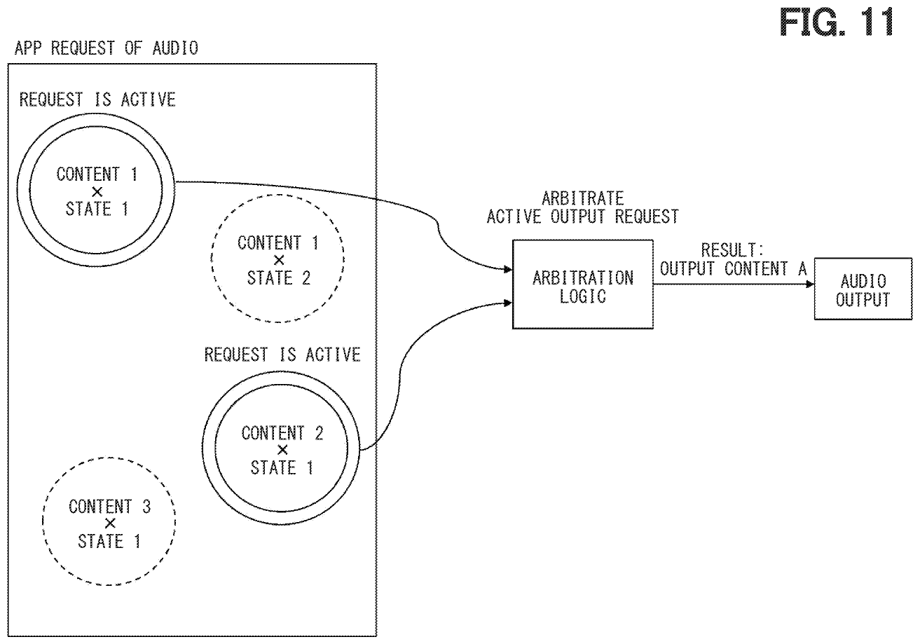

The APP request passes the value of audio content x state to the arbitration logic as a request from the application. The requests do not occur at the same time and always follow an order. The operation trigger of the arbitration logic is triggered by a request from an application, and arbitration is performed for each request. When there is a request from the application during the arbitration, the request is held and the arbitration of the request is performed again after the current arbitration. The requests are held in order. In addition, it is affected by a losing-time action determination processing constraint expression for changing the state of the request after arbitration and the loser type of the audio content property. The concept of the APP request is as illustrated in FIG. 11.

In the present embodiment, the memory 7 stores a rule definition regarding audio volume and a rule definition regarding behavior as rule definitions in consideration of requirements specific to the audio contents. Hereinafter, the rule definition related to the audio volume and the rule definition related to the behavior will be described.

### (1) Rule Definition Related to the Audio Volume

The arbitration unit 8 arbitrates the audio content in accordance with the rule definition related to the audio volume as the rule definition in consideration of the requirement specific to the audio content. For example, it is assumed that a music content is an audio content to be output to a music zone, and there is a requirement that the audio volume of the music zone is lowered (attenuated) when the interruption audio content is output. The attenuation state is a state of a zone, and the following constraint expression is used to realize the attenuation state of the zone when a specific condition is satisfied.

Constraint Interruption Audio Information Attenuates the Music Zone

```
    {
  description: “[Audio] The audio volume of the music zone is lowered
while the interruption audio information is being output”
  runtime: true
  interruption audio information. isSounding ( ) − > music zone.
  isAttenuated ( )
}
```

### (2) Rule Definition Related to the Behavior

Since the content of the audio content changes over time, it is necessary to determine whether to output the audio content from the beginning or from the middle. For example, when a non-output arbitration result is obtained and then an output arbitration result is obtained, the following two patterns are considered.

Pattern A: A state of the audio content that has lost in arbitration (i.e., lost audio content) is set to non-output, the output request is withdrawn, and the lost audio content starts to be newly output at the next output. The arbitration unit 8 performs arbitration of the audio content in accordance with a rule definition of behavior in which the state of the lost audio content is set to non-output and the lost audio content is newly output at the time of the next output.

Pattern B: The output of the audio content that has lost in arbitration (i.e., lost audio content) is temporarily stopped, the output request is continued, and the lost audio content is started to be output from a portion where the lost audio content is temporarily stopped at a time of the next output. The arbitration unit 8 performs arbitration of the audio content in accordance with a rule definition of behavior in which the output of the lost audio content is temporarily stopped and the lost audio content is started to be output from the portion where the lost audio content is temporarily stopped portion at the time of the next output.

The audio application has the following unified behavior.

Pattern A: The audio application outputs the APP request ON when the output condition of the audio content is satisfied, does not output the audio content when the arbitration is lost, and starts to newly output the audio content when the audio content is output as the initial arbitration result. The audio content of the pattern A is an audio content having a certain lifetime, such as a navigation audio content. That is, if the navigation audio content cannot win the arbitration at the timing of the APP request ON being output, even if the navigation audio content related to passing through the intersection is output at the timing when the subsequent output condition is satisfied, there is a high possibility that the vehicle has already passed through the corresponding intersection, and thus the navigation audio content has a lifetime. In this case, the behavior when losing in the arbitration is set to “withdraw the output request”.

Pattern B: The audio application outputs the APP request ON when the output condition of the audio content is satisfied, temporarily stops the output of the audio content when losing in the arbitration, and plays the audio content from the temporarily stopped portion when the APP request ON is not output but the audio content is output as the arbitration result. The audio content of the pattern B is an audio content that has no lifetime, and is, for example, a music content or the like. That is, in general, even when an interruption of several seconds occurs during output and the output is temporarily stopped, there is a high possibility that the user wants to output the music content from the portion where the output is temporarily stopped, and thus the music content has no life. In this case, “continue the output request” is set as the behavior when losing in the arbitration.

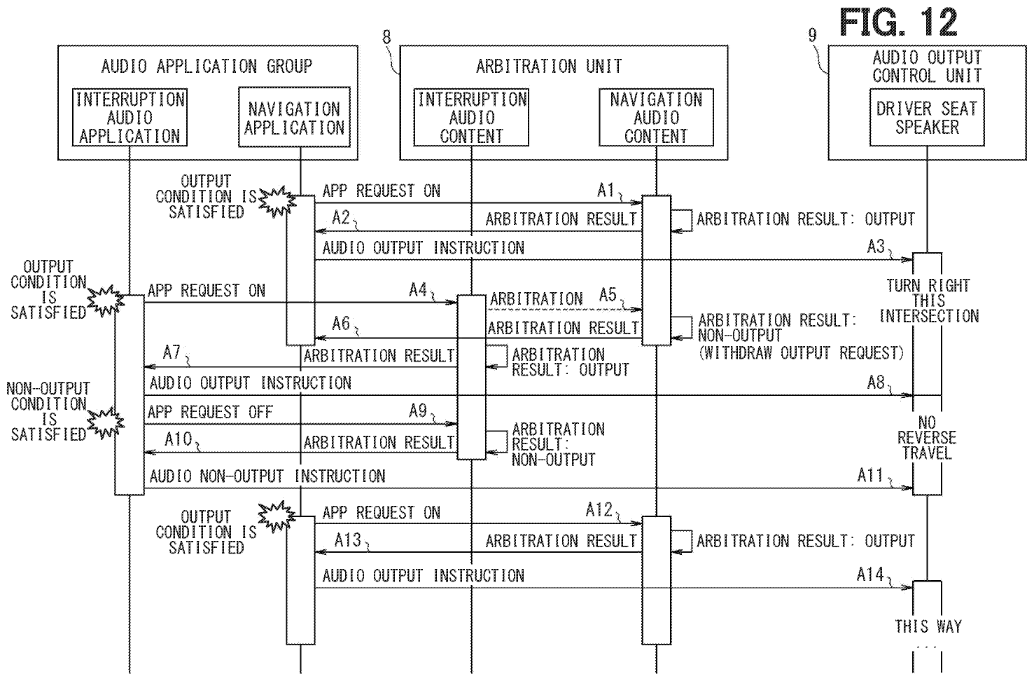

FIG. 12 illustrates a sequence of a process for the pattern A. When the output condition is satisfied, the navigation application outputs the APP request ON to the arbitration unit 8 (A1). When the APP request ON is input from the navigation application, the arbitration unit 8 arbitrates the navigation audio content and outputs an arbitration result indicating output to the navigation application (A2). When the navigation application receives the arbitration result indicating the output from the arbitration unit 8, the navigation application outputs an audio output instruction to the audio output control unit 9 (A3). When the audio output instruction is input from the navigation application, the audio output control unit 9 starts the output of a navigation audio from the driver seat speaker.

When the output condition is satisfied, the interruption audio application outputs the APP request ON to the arbitration unit 8 (A4). When the APP request ON is input from the interruption audio application, the arbitration unit 8 arbitrates the interruption audio content and the navigation audio content (A5). The arbitration unit 8 withdraws the output request from the navigation application, outputs an arbitration result indicating non-output to the navigation application (A6), and outputs an arbitration result indicating output to the interruption audio application (A7). When the interruption audio application receives the arbitration result indicating output from the arbitration unit 8, the interruption audio application outputs an audio output instruction to the audio output control unit 9 (A8). When the audio output instruction is input from the interruption audio application, the audio output control unit 9 stops the output of the navigation audio from the driver seat speaker halfway and starts the output of the interruption audio from the driver seat speaker.

When the non-output condition is satisfied, the interruption audio application outputs the APP request OFF to the arbitration unit 8 (A9). When the APP request OFF is input from the interruption audio application, the arbitration unit 8 arbitrates the interruption audio and outputs an arbitration result indicating non-output to the interruption audio application (A10). When the interruption audio application receives the arbitration result indicating non-output from the arbitration unit 8, the interruption audio application outputs an audio non-output instruction to the audio output control unit 9 (A11). When the audio output control unit 9 receives the audio non-output instruction from the interruption audio application, the audio output control unit 9 ends the output of the interruption audio from the driver seat speaker.

When the new output condition is satisfied, the navigation application outputs the APP request ON to the arbitration unit 8 (A12). When the APP request ON is input from the navigation application, the arbitration unit 8 arbitrates the navigation audio content and outputs an arbitration result indicating output to the navigation application (A13). Upon receiving the arbitration result indicating output from the arbitration unit 8, the navigation application outputs an audio output instruction to the audio output control unit 9 (A14). When the audio output instruction is input from the navigation application, the audio output control unit 9 starts the output of the navigation audio from the driver seat speaker.

In the example of FIG. 12, when the output condition is satisfied in the navigation application, for example, the output of the navigation audio “turn right at this intersection . . . ” is started. When the output condition is satisfied in the interruption audio application during the output of the navigation audio, the output of the navigation audio is terminated halfway, and the output of the interruption audio “no reverse travel” is started. When the non-output condition is satisfied in the interruption audio application, the output of the interruption audio is terminated. At this time, since the output request from the navigation application is withdrawn, the output of the navigation audio is not resumed even if the output of the interruption audio is ended. When a new output condition is satisfied in the navigation application, for example, output of another navigation audio “this way . . . ” is started.

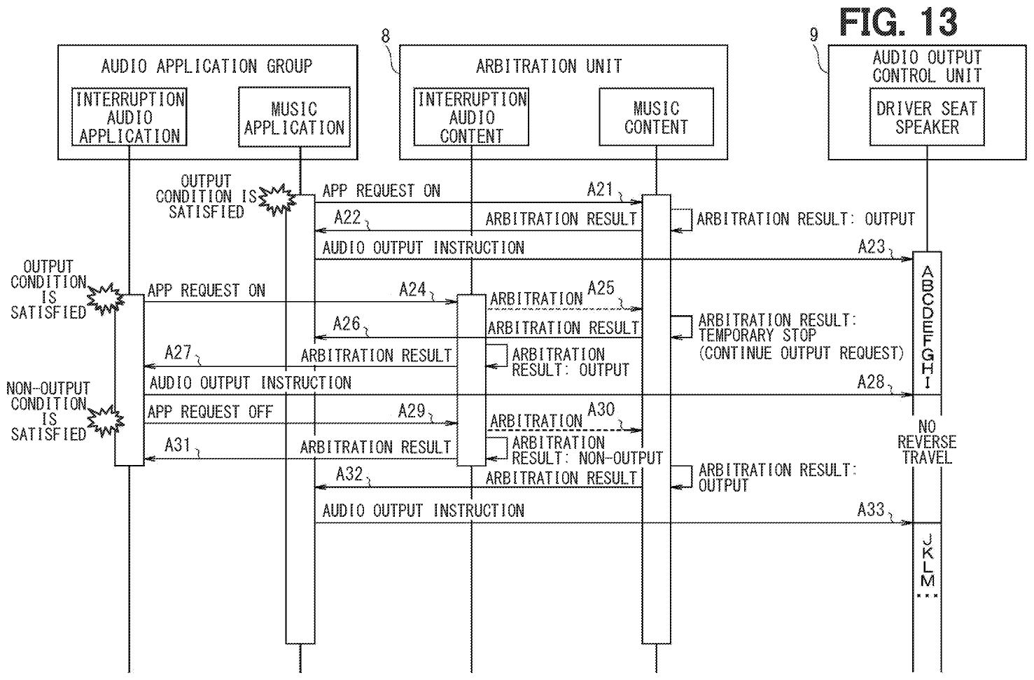

FIG. 13 illustrates a sequence of a process for the pattern B. When the output condition is satisfied, the music application outputs the APP request ON to the arbitration unit 8 (A21). When the APP request ON is input from the music application, the arbitration unit 8 arbitrates the music content and outputs an arbitration result indicating output to the music application (A22). Upon receiving the arbitration result indicating output from the arbitration unit 8, the music application outputs an audio output instruction to the audio output control unit 9 (A23). When the audio output instruction is input from the music application, the audio output control unit 9 starts outputting music from the driver seat speaker.

When the output condition is satisfied, the interruption audio application outputs the APP request ON to the arbitration unit 8 (A24). When the APP request ON is input from the interruption audio application, the arbitration unit 8 arbitrates the interruption audio content and the music content (A25). The arbitration unit 8 continues the output request from the music application, outputs an arbitration result indicating temporary stop to the music application (A26), and outputs an arbitration result indicating output to the interruption audio application (A27). When the interruption audio application receives the arbitration result indicating output from the arbitration unit 8, the interruption audio application outputs an audio output instruction to the audio output control unit 9 (A28). When the audio output instruction is input from the interruption audio application, the audio output control unit 9 temporarily stops the output of the music from the driver seat speaker and starts the output of the interruption audio from the driver seat speaker.

When the non-output condition is satisfied, the interruption audio application outputs the APP request OFF to the arbitration unit 8 (A29). When the APP request OFF is input from the interruption audio application, the arbitration unit 8 arbitrates the interruption audio and the music content (A30). The arbitration unit 8 outputs an arbitration result indicating non-output to the interruption audio application (A31), and outputs an arbitration result indicating output to the music application (A32).

Upon receiving the arbitration result indicating output from the arbitration unit 8, the music application outputs an audio output instruction to the audio output control unit 9 (A33). When the audio output instruction is input from the music application, the audio output control unit 9 ends the output of the interruption audio from the driver seat speaker, and resumes the output of the music from the driver seat speaker from the temporarily stopped portion.

In the example of FIG. 13, when the output condition is satisfied in the music application, the output of music is started. “ABC . . . GHI” shown in FIG. 13 indicates units constituting music. When the output condition is satisfied in the interruption audio application during the output of the music, the output of the music is temporarily stopped, and the output of the interruption audio “no reverse travel” is started. When the non-output condition is satisfied in the interruption audio application, the output of the interruption audio is terminated. At this time, since the output request from the music application is continued, when the output of the interruption audio is ended, the output of the music is resumed from the temporarily stopped portion. “JKL . . . ” shown in FIG. 13 indicates units following “ABC . . . GHI”.

In addition to the patterns A and B described above, the following pattern C is conceivable.

Pattern C: When the output state is changed to the non-output state, the output request is withdrawn. When the output state is changed to the non-output state, the arbitration unit 8 arbitrates the audio content according to the rule definition of the behavior of withdrawing the output request.

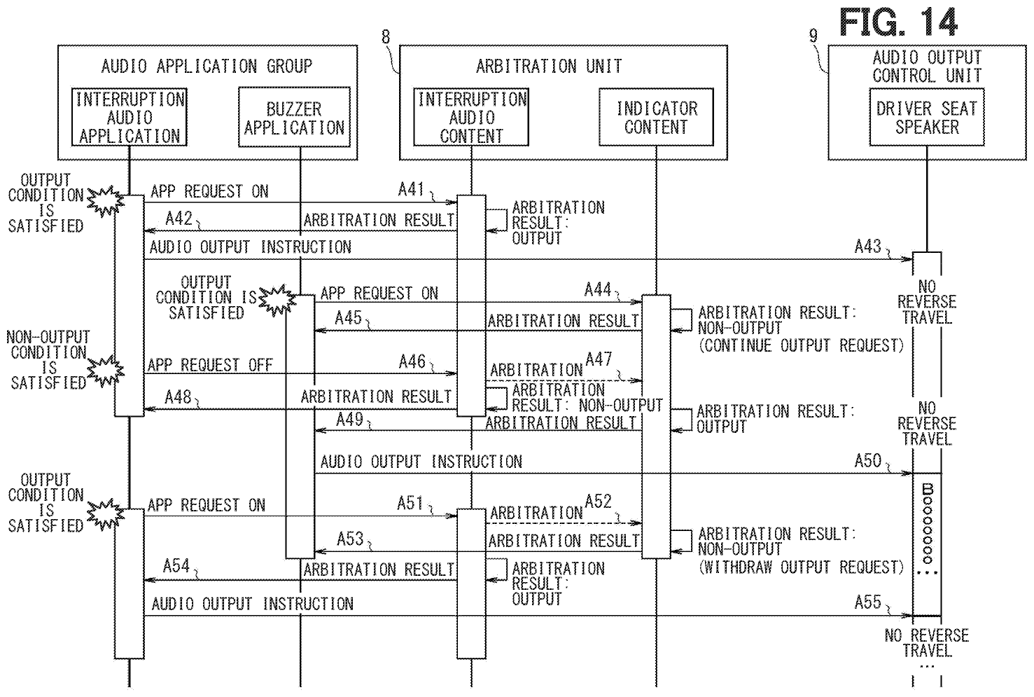

FIG. 14 illustrates a sequence of a process for the pattern C. When the output condition is satisfied, the interruption audio application outputs the APP request ON to the arbitration unit 8 (A41). When the APP request ON is input from the interruption audio application, the arbitration unit 8 arbitrates the interruption audio and outputs an arbitration result indicating output to the interruption audio application (A42). When the interruption audio application receives the arbitration result indicating output from the arbitration unit 8, the interruption audio application outputs an audio output instruction to the audio output control unit 9 (A43). When the audio output instruction is input from the interruption audio application, the audio output control unit 9 starts output of the interruption audio from the driver seat speaker.

When the output condition is satisfied, a buzzer application outputs the APP request ON to the arbitration unit 8 (A44). When the APP request ON is input from the buzzer application, the arbitration unit 8 continues the output request from the buzzer application, arbitrates an indicator content, and outputs an arbitration result indicating non-output to the buzzer application (A45).

When the non-output condition is satisfied, the interruption audio application outputs the APP request OFF to the arbitration unit 8 (A46). When the APP request OFF is input from the interruption audio application, the arbitration unit 8 arbitrates the interruption audio content and the indicator content (A47). The arbitration unit 8 outputs an arbitration result indicating non-output to the interruption audio application (A48), and outputs an arbitration result indicating output to the buzzer application (A49).

When the arbitration result indicating output is input from the arbitration unit 8, the buzzer application outputs an audio output instruction to the audio output control unit 9 (A50). When the audio output instruction is input from the buzzer application, the audio output control unit 9 ends the output of the interruption audio from the driver seat speaker and starts the output of a buzzer sound from the driver seat speaker.

When the new output condition is satisfied, the interruption audio application outputs the APP request ON to the arbitration unit 8 (A51). When the APP request ON is input from the interruption audio application, the arbitration unit 8 arbitrates the interruption audio content and the indicator content (A52). The arbitration unit 8 withdraws the output request from the buzzer application, outputs an arbitration result indicating non-output to the buzzer application (A53), and outputs an arbitration result indicating output to the interruption audio application (A54).

When the interruption audio application receives the arbitration result indicating output from the arbitration unit 8, the interruption audio application outputs an audio output instruction to the audio output control unit 9 (A55). When the audio output instruction is input from the interruption audio application, the audio output control unit 9 ends the output of the buzzer sound from the driver seat speaker and starts the output of the interruption audio from the driver seat speaker.

In the example of FIG. 14, when the output condition is satisfied in the interruption audio application, the output of the interruption audio is started. Even when the output condition is satisfied in the buzzer application during the output of the interruption audio, the output of the interruption audio “no reverse travel” is continued. When the non-output condition is satisfied in the interruption audio application, the output of the interruption audio is terminated. At this time, since the output request from the buzzer application is continued, the output of the buzzer sound of “Booo . . . ” for notifying the lighting of the indicator is started. When a new output condition is satisfied in the interruption audio application, the output of the buzzer sound is terminated, and the output of the interruption audio “no reverse travel” is started.

According to the present embodiment, the following effects can be obtained. In the audio output control device 1, the rule definition in consideration of the requirement specific to the audio content is stored, and the arbitration of the audio content is performed according to the rule definition in consideration of the requirement specific to the audio content. Accordingly, it is possible to easily manage the audio contents, and it is possible to easily change the specification and the design and to improve the quality.

The arbitration of the audio content is performed according to the rule definition related to the audio volume. The audio volume can be freely adjusted.

The arbitration of the audio contents is performed in accordance with the rule definition of the behavior in which the audio content that has lost in the arbitration is not output and the audio content is newly output at the next output. For example, it is possible to appropriately perform the behavior at the time of losing in the arbitration with respect to the audio content having a lifetime such as the navigation audio content.

The output of the audio content that has lost in the arbitration is temporarily stopped, and the audio content is arbitrated according to the rule definition of the behavior in which the audio content is started to be output from the temporarily stopped portion at the time of the next output. For example, it is possible to appropriately perform the behavior at the time of losing in the arbitration with respect to the audio content having no lifetime such as the music content.

When the output state is changed to the non-output state, the arbitration of the audio content is performed according to the rule definition of the behavior of withdrawing the output request. For example, it is possible to appropriately perform a behavior with respect to content that is desired to be notified to the driver at least once, such as the indicator content.

Although the present disclosure has been made in accordance with the embodiments, it is understood that the present disclosure is not limited to such embodiments and structures. The present disclosure incorporates various modifications and variations within a scope of equivalents. Additionally, various combinations and configurations, as well as other combinations and configurations including more, less, or only a single element, are within the scope and spirit of the present disclosure. It may be applied not only to the vehicle but also to the content output control device for purposes other than the vehicle.

The controllers and methods described in the present disclosure may be implemented by a special purpose computer which is configured with a memory and a processor programmed to execute one or more particular functions embodied in computer programs of the memory. Alternatively, the controllers described in the present disclosure and the methods thereof may be realized by a dedicated computer configured as a processor with one or more dedicated hardware logic circuits. Alternatively, the controller and methods described in the present disclosure may be realized by one or more dedicated computer, which is configured as a combination of a processor and a memory, which are programmed to perform one or more functions, and a processor which is configured with one or more hardware logic circuits. The computer program may be stored in a computer-readable non-transitory tangible storage medium as an instruction to be executed by the computer.

What is claimed is:

1. A content output control device comprising:
a memory that stores a rule definition including: an arbitration policy for defining basic arbitration when one of a plurality of audio contents is assigned to a zone; and a constraint expression;
an arbitration unit configured to perform arbitration of the plurality of audio contents according to the rule definition to satisfy rule-based arbitration upon receiving a plurality of output requests of the plurality of audio contents from a plurality of applications, respectively; and
an audio output control unit configured to control output of the one of the plurality of audio contents that is assigned to the zone when the arbitration of the plurality of audio contents is performed by the arbitration unit, wherein
the memory stores the rule definition in consideration of a plurality of requirements specific to the plurality of audio contents, respectively, and
the arbitration unit performs the arbitration of the plurality of audio contents in accordance with a rule definition regarding audio volume and a rule definition regarding behavior as the rule definition in consideration of the plurality of requirements specific to the plurality of audio contents.

2. The content output control device according to claim 1, wherein
one of the plurality of audio contents that has lost in the arbitration is defined as a lost audio content, and
the arbitration unit is configured to perform the arbitration of the plurality of audio contents in accordance with a rule definition of behavior in which a state of the lost audio content is set to non-output and the lost audio content is newly started to be output at a time of a next output.

3. The content output control device according to claim 1, wherein
one of the plurality of audio contents that has lost in the arbitration is defined as a lost audio content, and
the arbitration unit is configured to perform the arbitration of the plurality of audio contents in accordance with a rule definition of behavior in which the lost audio content is temporarily stopped, and the lost audio content is started to be output from a portion where the lost audio content is temporarily stopped at a time of a next output.

4. The content output control device according to claim 1, wherein
the arbitration unit is configured to perform the arbitration of the plurality of audio contents in accordance with a rule definition of behavior in which, in the plurality of output requests, an output request of the one of the plurality of audio contents is withdrawn in response to that a state of the one of the plurality of audio contents is changed from output to non-out.

5. A content output control method in a content output control device including a memory that stores a rule definition, the rule definition including: an arbitration policy defining basic arbitration when one of a plurality of audio contents is assigned to a zone; and a constraint expression and taking in consideration of a plurality of requirements specific to the plurality of audio contents, respectively, the content output control method comprising:
an arbitration procedure for arbitrating the plurality of audio contents so as to satisfy rule-based arbitration in accordance with a rule definition regarding audio volume and a rule definition regarding behavior as the rule definition in consideration of the plurality of requirements specific to the plurality of audio contents, upon receiving a plurality of output requests of the plurality of audio contents from a plurality of applications, respectively; and
an audio output control procedure for controlling output of the one of the plurality of audio contents that is assigned to the zone when the arbitration of the plurality of audio contents is performed in the arbitration procedure.

6. A non-transitory computer readable storage medium comprising instructions being executed by a computer in a content output control device including a memory that stores a rule definition, the rule definition including: an arbitration policy defining basic arbitration when one of a plurality of audio contents is assigned to a zone; and a constraint expression and taking in consideration of a plurality of requirements specific to the plurality of audio contents, respectively, the instructions causing the computer to execute:
an arbitration procedure for arbitrating the plurality of audio contents so as to satisfy rule-based arbitration in accordance with as rule definition regarding audio volume and a rule definition regarding behavior as the rule definition in consideration of the plurality of requirements specific to the plurality of audio contents, upon receiving a plurality of output requests of the plurality of audio contents from a plurality of applications, respectively; and
an audio output control procedure for controlling output of the one of the plurality of audio contents that is assigned to the zone when the arbitration of the plurality of audio contents is performed in the arbitration procedure.
